(19) United States
(12) Patent Application Publication
(10) Pub. No.: US 2012/0163711 A1
(43) Pub. Date: Jun. 28, 2012

(54) IMAGE PROCESSING APPARATUS, METHOD AND PROGRAM

(75) Inventor: Masamichi NAGONE, Tokyo (JP)

(73) Assignee: SONY CORPORATION, Tokyo (JP)

(21) Appl. No.: 13/287,543

(22) Filed: Nov. 2, 2011

(30) Foreign Application Priority Data
Dec. 28, 2010 (JP) P2010-292619

(51) Int. Cl. G06K 9/48

(52) U.S. Cl. 382/165; 382/199

(57) ABSTRACT

An image processing apparatus including a judgment unit that judges whether a continuous edge is detected or not in an image, and a preferential treatment unit that treats a predictive motion vector more preferentially than other motion vectors when the judgment unit judges that a continuous edge is detected.

### BACKGROUND

The present disclosure relates to image processing apparatuses, methods and programs, and in particular, to an image processing apparatus, a method and a program that are capable of preventing deterioration in image quality at the time of encoding.

In recent years, with the aim of effective transmission and storage of image information through the digitization of image data, image information apparatuses have become widely used that convert images into compressed codes with the use of encoding methods, in which an orthogonal transformation such as discrete cosine transform and motion compensation are used to compress the images by utilizing redundancy specific to image information. Among these methods, there is MPEG ((Moving Picture Experts Group), for example.

In particular, MPEG-2 (ISO/IEC 13818-2) is defined as a general-purpose image encoding method, and a standard that supports both interlaced scanning images and progressive scanning images, and also supports both normal-definition images and high-definition images. For example, MPEG-2 is currently used for a wide range of applications from consumer-use purposes to professional-use purposes. MPEG-2 was originally designed for high-quality image coding used mainly for broadcasting, but did not support encoding methods having an amount of code (bit rate) lower than that supported by MPEG-1, that is, MPEG-2 did not support higher compression ratio encoding methods. As a result of wide use of portable terminal devices, it is expected that it will be increasingly necessary to use a higher compression ratio encoding method in the near future. In response to this situation, the standardization of an MPEG-4 encoding method has been achieved. As an image encoding method, the MPEG-4 standard was officially approved in December 1998 as international standard ISO/IEC 14496-2.

In addition, there is a standard called H.26L (ITU-T Q6/16 VCEG). In H.26L, a larger amount of calculation for encoding and decoding is performed compared with other encoding methods such as MPEG-2 and MPEG-4. However, it is recognized that H.26L achieves a higher encoding efficiency. Afterward, as one of MPEG-4 activities, the standardization of an encoding scheme called Joint Model of Enhanced-Compression Video Coding has been studied on the basis of H.26L, in which the encoding scheme employs functions not supported by H.26L in order to realize higher encoding efficiency. The above encoding scheme was approved in March 2003 as an international standard H.264/MPEG-4 Part10 (Advanced Video Coding) (referred to as H.264/AVC hereinafter). The software, documentation and the like for H.264/AVC can be obtained from the Internet site “H.264/AVC Software Coordination [online]” (URL: http://iphome.hhi.de/suehring/tml/) (at the date of Dec. 9, 2010).

### SUMMARY

There is a possibility that deterioration in image quality will occur in the encoding of images. FIG. 1 shows an example of deterioration in image quality. FIG. 1 is a picture in which motion vectors detected at the time of encoding an image are visualized using predetermined analytic software, and the visualized motion vectors are superimposed on the image. FIG. 1 shows a photograph of a high-rise building, and this photograph is obtained by superimposing visualized motion vectors on an image obtained by photographing the high-rise building with the use of a camera tilted from bottom to top. In FIG. 1, lines composed of white dots show the motion vectors (however, directions of the lines are not shown in FIG. 1). On an image photographed using a camera tilted from bottom to top, motion vectors are detected as vectors moving the same distance in the same direction. Therefore, when such motion vectors are visualized, they show lines of the same length that are composed of dots.

In FIG. 1, however, because some motion vectors with directions and lengths different from directions and lengths of other motion vectors are observed, there exist some lines with lengths different from lengths of other lines in an area surrounded by an oval 11. FIG. 2 shows an enlarged view of a part of the oval 11 in FIG. 1. Among the motion vectors shown in FIG. 2, the length of a motion vector 21 is different from that of a motion vector 22, for example. In FIG. 1, there are many motion vectors the lengths of which are the same as that of the motion vector 22, therefore it can be judged that the motion vector 22 is a vector accurately detected. On the contrary, it can be judged that the motion vector 21 is a vector erroneously detected. Because such an erroneous detection of a motion vector leads to deterioration in image quality, it is desired to prevent such an erroneous detection from occurring.

FIG. 3 shows another example. FIG. 3 shows a picture in which visualized motion vectors are superimposed on an image obtained by photographing a street where cars come and go using a camera fixed at a spot along a roadway. As with in FIG. 1, lines composed of white dots show the motion vectors in FIG. 3. The picture shown in FIG. 3 is obtained by photographing a street using a camera fixed at a spot along a roadway. Therefore, because an image in which the roadway does not move, and cars are moving is photographed, it is conceivable that motion vectors are not detected from the roadway, but detected from the cars.

When referring to FIG. 3, however, there are lines that indicate motion vectors detected on parts of the roadway around cars in an oval 31. When referring to FIG. 3, it can be found out that motion vectors are detected not only in an area surrounded by the oval 13 but also in other areas and on still objects near to moving objects. As described above, there is a case where a motion vector that may not be detected fundamentally is detected in the vicinity of a moving object, which leads to deterioration in image quality. Therefore, it is desired to prevent such an erroneous detection from occurring.

The present disclosure is achieved with the above-described problems borne in mind, and can prevent deterioration in image quality owing to encoding from occurring.

An image processing apparatus according to an embodiment of the present disclosure includes: a judgment unit that judges whether a continuous edge is detected or not in an image; and a preferential treatment unit that treats a predictive motion vector more preferentially than other motion vectors when the judgment unit judges that a continuous edge is detected.

The judgment unit can use mode information regarding a chroma intra mode.

The judgment unit can judge that a continuous edge is detected when the chroma intra mode is a horizontal prediction mode or a vertical prediction mode.

The preferential treatment unit can subtract a predetermined value from a cost function value of the predictive motion vector.

An image processing method according to an embodiment of the present disclosure is an image processing method performed by an image processing apparatus equipped with a judgment unit and a preferential treatment unit, and the method includes: the step of causing the judgment unit to judge whether a continuous edge is detected or not in an image; and the step of causing the preferential treatment unit that treats a predictive motion vector more preferentially than other motion vectors when the judgment unit judges that a continuous edge is detected.

A program according to an embodiment of the present disclosure is a program that causes a computer for controlling an image processing apparatus equipped with a judgment unit and a preferential treatment unit to perform processing including: the step of making the judgment unit judge whether a continuous edge is detected or not in an image; and the step of making the preferential treatment unit treat a predictive motion vector more preferentially than other motion vectors when the judgment unit judges that a continuous edge is detected.

In an image processing apparatus, a method and a program according to an embodiment of the present disclosure, when a continuous edge is detected in an image, a predictive motion vector is more preferentially treated than other motion vectors.

According to an embodiment of the present disclosure, deterioration in image quality at the time of encoding can be prevented from occurring.

### BRIEF DESCRIPTION OF THE DRAWINGS

FIG. 1 is a picture for explaining detected motion vectors;

FIG. 2 is a picture for explaining detected motion vectors;

FIG. 3 is a picture for explaining detected motion vectors;

FIG. 4 is a diagram showing a configuration example of an encoder according to an embodiment;

FIG. 5 is a diagram for explaining interlace;

FIG. 6 is a diagram for explaining an erroneous detection;

FIG. 7 is a picture for explaining detected motion vectors;

FIG. 8 is a flowchart for explaining the operation of a motion prediction unit;

FIG. 9 is a table for explaining an intra chroma mode; and

FIG. 10 is a diagram for explaining storage media.

### DETAILED DESCRIPTION OF EMBODIMENTS

An embodiment of the present disclosure will be described with reference to the accompanying drawings hereinafter.

[Configuration Example of Encoder]

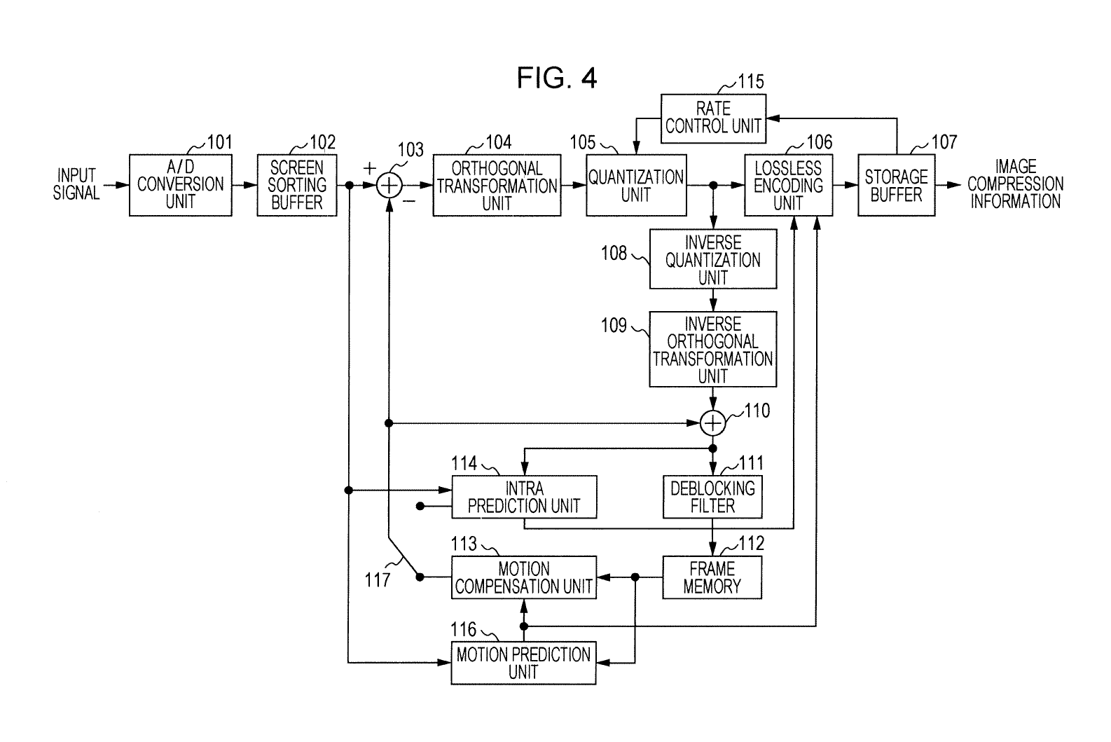

FIG. 4 is a block diagram showing a configuration example of an encoder that conforms to an AVC (Advanced Video Coding) method. The encoder shown in FIG. 4 includes an A/D conversion unit 101, a screen sorting buffer 102, an arithmetic unit 103, an orthogonal transformation unit 104, a quantization unit 105, a lossless encoding unit 106, a storage buffer 107, an inverse quantization unit 108, an inverse orthogonal transformation unit 109, an addition unit 110, a deblocking filter 111, a frame memory 112, a motion compensation unit 113, an intra prediction unit 114, a rate control unit 115, a motion prediction unit 116, and a selection unit 117. The encoder in FIG. 4 compresses and encodes an input image in accordance with AVC method.

To put it concretely, the A/D conversion unit 101 of the encoder performs A/D conversion on images in units of frames input as input signals, and then outputs the converted image data to the screen sorting unit 102 so that the converted image data is stored in the screen sorting buffer 102. The screen sorting buffer 102 sorts the stored display-sequenced images of frames so that they match the order of encoding in accordance with the relevant GOP (Group of Pictures) structure.

The arithmetic unit 103 subtracts a predictive image supplied by the selection unit 117 from an image read out from the screen sorting buffer 102 if necessary. The arithmetic unit 103 outputs an image obtained by the above subtraction to the orthogonal transformation unit 104 as difference information. If a predictive image is not supplied by the selection unit 117, the arithmetic unit 103 outputs the image read out from the screen sorting buffer 102 as it is to the orthogonal transformation unit 104 as difference information.

The orthogonal transformation unit 104 performs orthogonal transformation processing on the difference information sent from the arithmetic unit 103 on a block-size-by-block-size basis, and supplies coefficients obtained as a result of the orthogonal transformation processing to the quantization unit 105. The quantization unit 105 quantizes the coefficients supplied by the orthogonal transformation unit 104. The quantized coefficients are sent to the lossless encoding unit 106. The lossless encoding unit 106 obtains information indicating an optimal intra prediction mode (referred to as intra prediction mode information hereinafter) from the intra prediction unit 114, and obtains information indicating an optimal inter prediction mode (referred to as inter prediction mode information hereinafter), information about motion vectors and the like from the motion prediction unit 116.

The lossless encoding unit 106 performs lossless encoding such as variable length encoding (CAVLC (Context-Adaptive Variable Length Coding)), arithmetic encoding (CABAC(Context-Adaptive Binary Arithmetic Coding)) or the like on the quantized coefficients supplied by the quantization unit 105, and makes a compressed image from the resulting information. In addition, the lossless encoding unit 106 performs lossless encoding on the intra prediction mode information, the inter prediction mode information, the information about motion vectors and the like, and appends the resulting information to the compressed image as header information. The lossless encoding unit 106 supplies information about the compressed image along with the header information, which is obtained by the lossless encoding, to the storage buffer 107 as image compression information, so that the information is stored in the storage buffer 107.

The storage buffer 107 temporarily stores the image compression information supplied by the lossless encoding unit 106, and then outputs the information to a recording unit or to a transmission line in subsequent stages (neither is shown). In addition, the quantized coefficients output from the quantization unit 105 are also sent to the inverse quantization unit 108, and inversely quantized. The inversely quantized coefficients are supplied to the inverse orthogonal transformation unit 109 by the inverse quantization unit 108.

The inverse orthogonal transformation unit 109 performs inverse orthogonal transformation on the coefficients supplied by the inverse quantization unit 108 on a block-size-by-block-size basis. Difference information obtained through the inverse orthogonal transformation is sent to the addition unit 110. The addition unit 110 adds the difference information supplied by the inverse orthogonal transformation unit 109 to the predictive image supplied by the intra prediction unit 114 or the motion compensation unit 113 to obtain a locally decoded image. The addition unit 110 supplies the obtained image to the intra prediction unit 114 as a reference image as well as to the deblocking filter 111.

The deblocking filter 111 eliminates block distortion from the locally decoded image supplied by the addition unit 110 by filtering the image. The deblocking filter 111 supplies the resultant image to the frame memory 112 so that the image is stored in the frame memory 112. The image stored in the frame memory 112 is output to the motion compensation unit 113 and to the motion prediction unit 116 as a reference image.

The motion compensation unit 113 performs compensation processing on the reference image supplied from the frame memory 112 on the basis of motion vectors and the inter prediction mode information supplied by the motion prediction unit 116, and creates a predictive image. The motion compensation unit 113 supplies a cost function value (described later in detail) supplied by the motion prediction unit 116 and the created predictive image to the selection unit 117.

Here, the cost function value is also called an RD (Rate Distortion) cost function value, and it is calculated on the basis of one of two methods, that is, High Complexity mode or Low Complexity mode that are prescribed by JM (Joint Model), i.e., reference software employed by AVC method.

To put it concretely, if the High Complexity mode is adopted as a calculation method of the cost function value, the processes from the AD conversion to the lossless encoding are provisionally performed for each of the candidate prediction modes, and a cost function value expressed by the next equation (1) is calculated for each prediction mode.

Cost=D+λ×R (1)

Here, D is a difference (distortion) between the original image and the decoded image, R is a generated code amount including the coefficients obtained by the orthogonal transformation, and λ is a Lagrange multiplier given as a function of a quantization parameter QP.

On the other hand, if the Low Complexity mode is adopted as a calculation method of the cost function value, creation of a decoded image and calculation of a header bit showing information about each prediction mode and the like are performed for each of all candidate prediction modes, and a cost function value expressed by the next equation (2) is calculated for each prediction mode.

Cost=D+QPtoQuant(QP)×Header_Bit (2)

Here, D is a difference (distortion) between the original image and the decoded image, QPtoQuant is a function (Q value) given as a function of a quantization parameter QP, and Header_Bit is a header bit for the prediction mode.

In the Low Complexity mode, because a decoded image only has to be created for each of the prediction modes, and it is not necessary for the lossless encoding to be performed for each prediction mode, a small amount of calculation is sufficient. In the following description of this specification, it will be assumed that the Low Complexity mode is adopted as the calculation method for the cost function value.

The intra prediction unit 114 performs intra prediction processing for all candidate intra prediction modes in units of blocks of all candidate block sizes on the basis of an image read out from the screen sorting buffer 102 and the relevant reference image supplied from the addition unit 110, and creates predictive images.

In addition, the intra prediction unit 114 calculates cost function values for all the candidate intra prediction modes and for the blocks of all block sizes. Next, the intra prediction unit 114 determines that a combination of an intra prediction mode and a block size that produces the minimum cost function value is an optimal intra prediction mode. The intra prediction unit 114 supplies a predictive image created by the optimal intra prediction mode and the relevant cost function value to the selection unit 117. Upon being informed by the selection unit 117 that the selection unit 117 has selected the predictive image created by the optimal intra prediction mode, the intra prediction unit 114 supplies the intra prediction mode information to the lossless encoding unit 106.

The motion prediction unit 116 performs motion prediction for all candidate inter prediction modes on the basis of an image supplied from the screen sorting buffer 102 and the relevant reference image supplied from the frame memory 112, and creates motion vectors for all the candidate inter prediction modes. At this time, the motion prediction unit 116 calculates cost function values for all the candidate inter prediction modes, and determines that an inter prediction mode that produces the minimum cost function value is an optimal inter prediction mode. Next, the motion prediction unit 116 supplies the inter prediction mode information, the relevant motion vector and the relevant cost function value to the motion compensation unit 113. Upon being informed by the selection unit 117 that the selection unit 117 has selected the predictive image created by the optimal inter prediction mode, the motion prediction unit 116 supplies the inter prediction mode information, the relevant motion vector information and the like to the lossless encoding unit 106.

The selection unit 117 determines that either the optimal intra prediction mode or the optimal inter prediction mode is an optimal prediction mode on the basis of cost function values supplied from the intra prediction unit 114 and the motion compensation unit 113. Afterward, the selection unit 117 supplies the predicted image relevant to the optimal prediction mode to the arithmetic unit 103 and the addition unit 110. In addition, the selection unit 117 informs the intra prediction unit 114 or the motion prediction unit 116 that it has selected the predicted image relevant to the optimal prediction mode.

The rate control unit 115 controls the rate of the quantization operation of the quantization unit 105 so that overflow or underflow does not occur on the basis of the image compression information stored in the storage buffer 107.

[Creation of Motion Vectors]

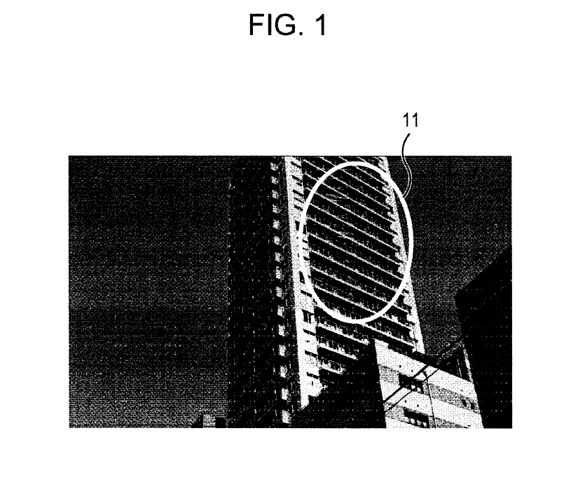

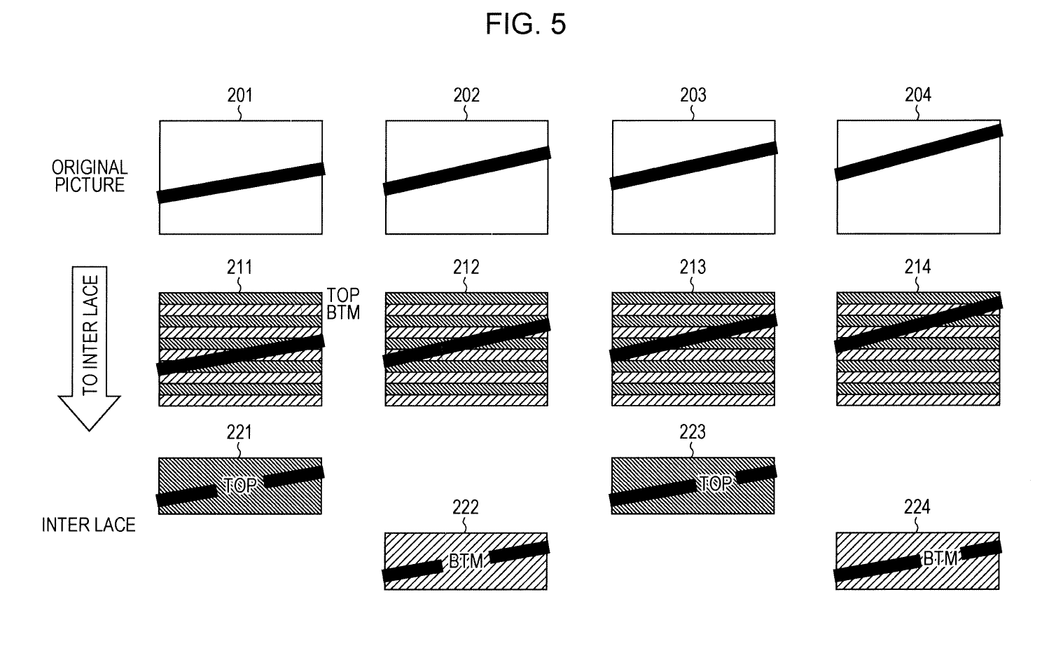

Next, the creation of motion vectors performed by the motion prediction unit 116 will be explained. FIG. 1 to FIG. 3 will be referred to again. A possibility that motion vectors are erroneously detected has been described with reference to FIG. 1 to FIG. 3. One of causes for erroneous detection will be explained with reference to FIG. 5. In FIG. 5, pictures 201 to 204 show original pictures. In chronological order, the original picture 202 appears after the original picture 201, the original picture 203 appears after the original picture 202, and the original picture 204 appears after the original picture 203. In the original pictures 201 to 204, diagonal lines are depicted. Individual diagonal lines depicted in the original pictures 201 to 204 move from bottom to top with time.

Original pictures 211 to 214 schematically show scanning lines used for performing interlaced scanning on the original pictures 201 to 204. A top field 221 is created from the original picture 211, and a bottom field 222 is created from the original picture 212. In a similar way, a top field 223 is created from the original picture 213, and a bottom field 224 is created from the original picture 214. As above, one field is created from one original picture. Therefore, in the case of the diagonal line shown in FIG. 5, when referring to only the top field 221, for example, a part of the diagonal line is missing because the part of the diagonal line is included in the bottom field 222.

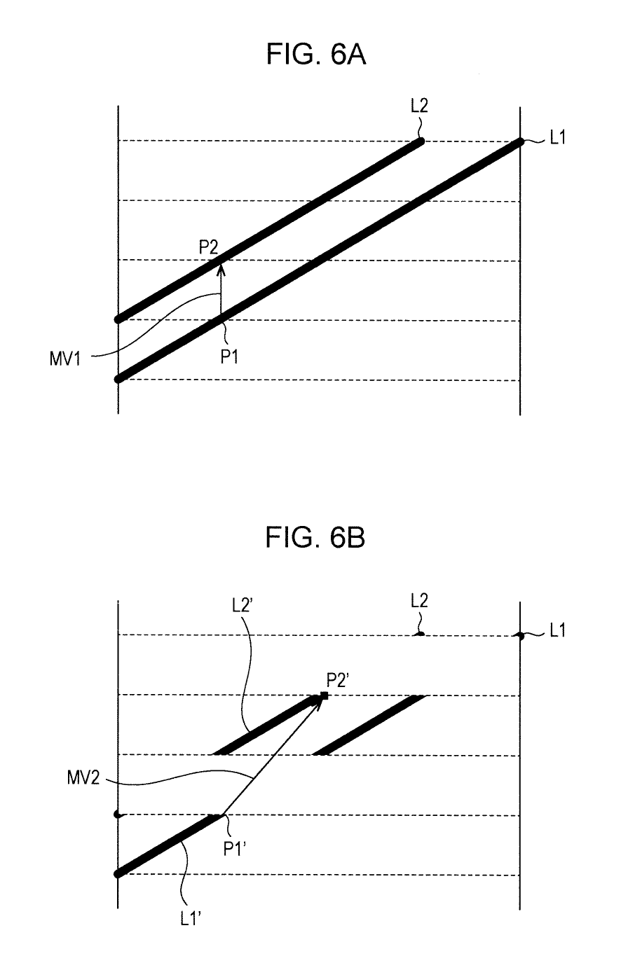

There is a possibility that an erroneous detection will occur when a motion vector is detected by comparing two fields that are individually lacking in a part of information, for example, by comparing the top fields 221 and 223, or by comparing the bottom fields 222 and 224. The detection of a motion vector using the top fields 221 and 223 will be described in detail with reference to FIG. 6.

FIG. 6A is an enlarged view of a part of a picture obtained by hypothetically overlapping the original picture 201 with the original picture 203. A diagonal line L1 depicts the diagonal line in the original picture 201, and a diagonal line L2 depicts the diagonal line in the original picture 203. FIG. 6A shows that the diagonal line L1 in the original picture 201 moves upward to the position of the diagonal line L2 in the original picture 203. Because the diagonal line L1 only moves upward as above, essentially a motion vector to be detected has to be a motion vector MV1 whose direction is upward as shown in FIG. 6A. In other words, it is observed that a point Pl on the diagonal line L1 moves to the position of a point P2 on the diagonal line L2, and the motion vector MV1 is detected.

However, in the case where a motion vector is detected on the basis of the top field 221 and the top field 223 as shown in FIG. 6B, there is a possibility that an erroneous motion vector MV2 will be detected as the motion vector. FIG. 6B is an enlarged view of a part of a picture obtained by hypothetically overlapping the top field 221 with the top field 223. Only a part of the diagonal line L1 and a part of the diagonal line L2 shown in FIG. 6B are included in the top fields 221 and 223 respectively.

Although a diagonal line L1′, a part of the diagonal line L1, essentially moves to a part of a diagonal line L2 included in the bottom field 222, the diagonal line L1′ is not included in the top field 223. Therefore, when the relevant motion vector is detected, a diagonal line L2′, which is a part of the diagonal line L2 included in the top field 223, is used. As a result, if the motion vector is detected using the diagonal line L1′ and the diagonal line L2′, it is judged that a point P1′ on the diagonal line L1′ moves to a point P2′ on the diagonal line L2′. Therefore, there is a possibility that a motion vector MV2 will be detected.

It is conceivable that the above is one of the causes of the erroneous detection of a motion vector. The above is one of the causes, and there may be other causes of the detection of an erroneous motion vector. In addition, although a diagonal line is used as an example of an explanatory material in the above description, there is a possibility that an erroneous detection will occur in the case of a vertical line or a horizontal line. Regardless of causes of the erroneous detection, as described with reference to FIG. 1 to FIG. 3, if there are some erroneously detected motion vectors mixed with accurately detected motion vectors, there is a possibility that deterioration in image quality will occur.

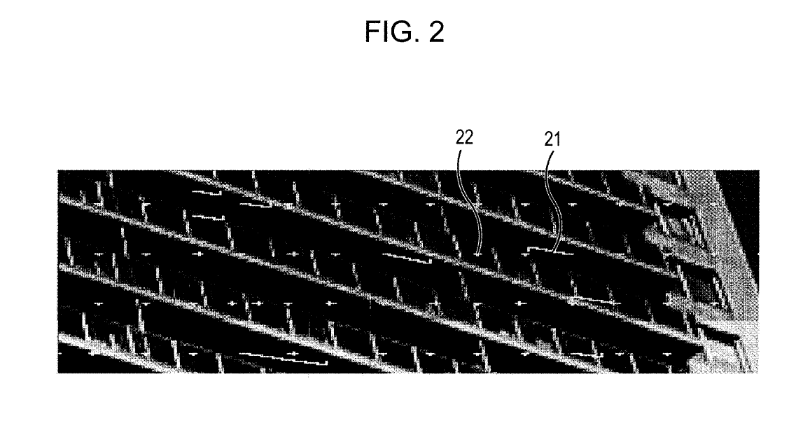

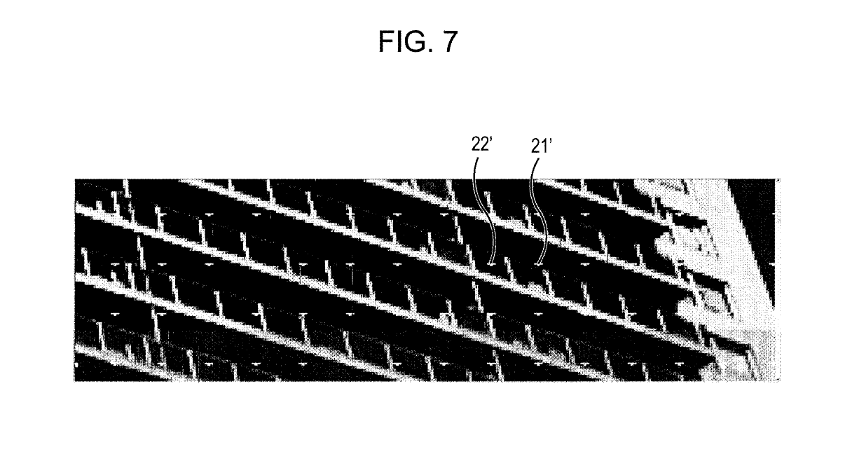

Therefore, measures to prevent such an erroneous detection from occurring will be taken in the present disclosure. A below-described process performed by the motion prediction unit 116 leads to a result shown in FIG. 7. FIG. 7 shows an enlarged view of a part of the oval 11 in FIG. 1, and the part of the oval 11 shown in FIG. 7 is the same part shown in FIG. 2. However, FIG. 7 shows motion vectors that are calculated by a process different from that used in the case of FIG. 2. Description of FIG. 7 will be made in comparison with FIG. 2. In FIG. 2, it can be found that the length of a motion vector 21 is different from that of a motion vector 22. On the other hand, it can be found that motion vectors 21′ and 22′ in FIG. 7, which are respectively counterparts of the motion vectors 21 and 22 in FIG. 2, have the same magnitudes.

As described above, the number of motion vectors erroneously detected can be reduced by performing the below-described process. Therefore, deterioration in image quality owing to encoding can be prevented from occurring.

[Processing by Motion Prediction Unit 116]

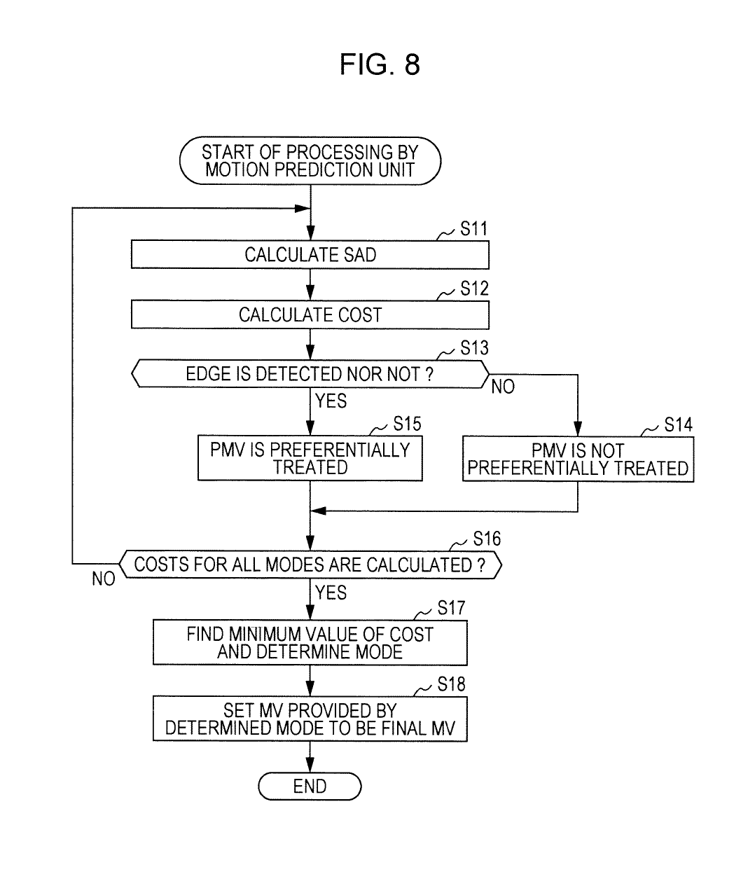

Next, processing performed by the motion prediction unit 116 will be described below. FIG. 8 is a flowchart for explaining processing performed by the motion prediction unit 116. The motion prediction unit 116 performs motion prediction for all candidate inter prediction modes on the basis of an image supplied from the screen sorting buffer 102 and the relevant reference image supplied from the frame memory 112, and creates motion vectors for all the candidate inter prediction modes.

An SAD is calculated at step S11. SAD is an abbreviation for a sum of absolute differences. The SAD is calculated, for example, when block matching is executed. A standard image M₁ is divided into plural standard blocks, and block matching is executed for each of standard blocks. In other word, a position of a compared image Mₙ to which a standard block is displaced is searched for, and the displacement amount is detected as a motion vector regarding the standard block.

A searched area of the compared image Mₙ that is searched for a position to which the standard block is displaced is set relative to the position of the standard block. To be accurate, a reference block, whose size is the same as that of the standard block, is shifted on a pixel-by-pixel basis within the searched area of the compared image Mₙ to search for a position of the reference block that is most similar to the standard block. In other words, a correlation value between the standard block and the reference block is used as an evaluation value for evaluating the degree of similarity between the standard block and the reference block, and this correlation value is calculated for each position of the reference block within the search area.

When considering an absolute value of a difference between a luminance value of a pixel in the standard block and a luminance value of a pixel that is located in relatively the same position in the reference block, an SAD that is a sum of absolute values of all pixels in the standard block and in the reference block is used as a correlation value. At step S11, a motion vector of the standard block is detected on the basis of coordinates (relative coordinates) of the reference block that makes the correlation value SAD minimum. The minimum SAD is also used in the next equation.

At step S12, Cost (a cost function value) is calculated. The cost function value is calculated on the basis of one of two methods, that is, the High Complexity mode or the Low Complexity that are prescribed by JM (Joint Model), i.e., reference software employed by the AVC method. Because it will be assumed that the Low Complexity mode is adopted hereinafter, the cost function value is calculated using Equation (2). Equation (2) is the same as that described before, and is as follows.

Cost=D+QPtoQuant(QP)×Header_Bit (2)

D is a difference (distortion) between the original image and the decoded image, and in this case the SAD calculated at step S11 is used as D. QPtoQuant is a function (Q value) given as a function of a quantization parameter QP, and Header Bit is a header bit for the prediction mode. Replacing D with SAD, the next equation (2)′ is obtained. A value calculated using Equation (2)′ is described as a normal cost function value.

Cost=SAD+QPtoQuant(QP)×Header_Bit (2)

At step S13, it is judged whether an edge is detected or not. If it is judged that an edge is not detected at step S13, the flow proceeds to step S14, and if it is judged that an edge is detected at step S13, the flow proceeds to step S15. At step S14, the setting that a PMV (predicted motion vector) is not preferentially treated is set, and a cost function value of the PMV is calculated. The value calculated at step S14 is described as a normal cost function value.

If a block regarding which the PMV is calculated is a macroblock (referred to as a current macroblock hereinafter), it will be assumed that the macro blocks situated to the left side, to the upper left side, to the upper side, and to the upper right side of the current macroblock are macro blocks A, B, C, and D respectively, and the marcoblocks A, B, C, and D have already been encoded. In this case, the predictive motion vector PMV regarding the current macroblock is calculated using the motion vectors MVa of the macroblock A, MVb of the macroblock B, MVc of the macroblock C, and MVd of the macroblock D. To put it concretely, the PMV is obtained as a median of the motion vectors MVa, MVb, MVc, and MVd.

On the other hand, if it is judged that an edge is detected at step S13, the setting that the PMV is preferentially treated is made, and a cost function value of the PMV is calculated. If the PMV is preferentially treated, the cost function value is calculated on the basis of the next equation (4).

Cost_{—}PMV=SAD+QPtoQuant(QP)×Header_Bit-PMVoffset (4)

Equation (4) calculates a cost function value by subtracting PMVoffset from a normal cost function value obtained from Equation (2)′. The value calculated by Equation (4) is described as a PMV preferential treatment cost function value. As described latter, the minimum cost function value among normal cost function values and the PMV preferential treatment cost function value is selected. PMV preferential treatment means that a PMV preferential treatment cost function value is reduced by subtracting the value of offset (PMVoffset) from a normal cost function value as shown in Equation (4) so that the PMV preferential function value is more easily selected than other cost function values.

When a PMV is preferentially treated, the relevant PMV preferential treatment is performed by subtracting a predetermined value (PMVoffset) from a PMV calculated using motion vectors detected from the peripheral blocks. The reason why a PMV is preferentially treated when an edge is found will be described later, and let us continue to explain the flowchart in FIG. 8. After either the case where the PMV is not preferentially treated at step S14 or the case where the PMV is preferentially treated at step S15, the flow proceeds to step S16. At step S16, it is judged whether cost function values are calculated for all modes. There are eight modes, that is, 16×16 mode, 16×8 mode, 8×16 mode, 8×8 mode, 4×8 mode, 8×4 mode, 4×4 mode and PMV mode.

Because processes at step S13 to step S15 are associated with only PMV mode, it can be set that these processes are performed only in PMV mode. For example, by setting a judging process for judging whether the current mode is PMV mode or not between step S12 and step S13, it becomes possible that the flow proceeds to step S13 if the current mode is PMV mode, and the flow proceeds to step S16 if the current mode is not PMV mode.

At step S16, if it is judged that cost function values are not calculated for all modes, the flow goes back to step S11, and the flow goes to a mode for which calculation of the relevant cost function value has not been finished to repeat processes at step S11 and later. On the other hand, at step S16, if it is judged that cost function values are calculated for all modes, the flow proceeds to step S17. At step S17, among calculated normal cost function values and a PMV preferential treatment cost function value, the minimum cost function value is selected, and a mode relevant to the minimum cost function value is determined. Next, at step S18, an MV (motion vector) for the determined mode is set to be a final motion vector.

As described above, it is judged whether a predetermined situation is satisfied or not, and more concretely it is judged whether the situation that an edge is detected in an image or not is satisfied or not in the above embodiment of the present disclosure. If the predetermined situation is satisfied, a predicted motion vector (PMV) is more preferentially treated than other motion vectors. By performing such a preferential treatment, the accuracy of a detected motion vector can be improved.

[PMV Preferential Treatment]

The reason why a PMV is preferentially treated so that the relevant PMV mode is advantageously selected when an edge is found at step S13 will be described below. As described above, the predictive motion vector PMV regarding the current macroblock is calculated using the motion vectors of the already-encoded macroblocks respectively situated to the left side, to the upper left side, to the upper side, and to the upper right side of the current macroblock. In other words, because the PMV is calculated from the motion vectors of the peripheral macroblocks, it is susceptible to the peripheral macroblocks. Therefore, a PMV is recommendable to be used if it is desired that a motion vector is matched with motion vectors of peripheral macroblocks.

For example, in the case of an image described with reference to FIG. 1 (or FIG. 2), by using a PMV, a motion vector to be obtained can be matched with adjacent motion vectors. For example, the motion vector 21 shown in FIG. 2 can be matched with the motion vector 22. When the motion vector 21 is made to be matched with the motion vector 22, a state in which there are no erroneously detected vectors can be obtained as shown in FIG. 7.

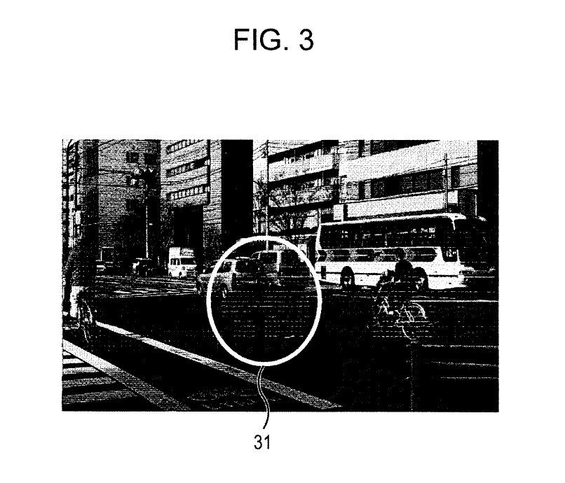

On the contrary, because a PMV is susceptible to adjacent motion vectors, if it is used in a situation where it is not desirable that a motion vector to be obtained is matched with adjacent motion vectors, there is a high possibility that a motion vector is erroneously detected. For example, as described with reference to FIG. 3, if a motion vector regarding a roadway is made to be matched with a motion vector that is detected on the basis of the motion of a car when an image of the car coming and going along the roadway is photographed by a camera fixed at a spot, the motion vector regarding the roadway is erroneously detected although it is essentially desirable that no motion vectors are detected from the roadway. In such a case, it is preferable not to use a PMV.

As described above, there are two situations: one is a situation where it is preferable to use a PMV; and the other is a situation where it is preferable not to use a PMV. In a situation such as one that is explained with reference to FIG. 1, it is preferable to use a PMV. On the other hand, in a situation such as one that is explained with reference to FIG. 3, it is preferable not to use a PMV. Therefore, it is necessary to control the operation of the motion prediction unit so that, when it is preferable to use a PMV, PMV preferential treatment is adopted in order that the PMV is advantageously selected, and when it is preferable not to use a PMV, PMV preferential treatment is not adopted in order that the PMV is not advantageously selected. As described above, in the flowchart in FIG. 8, the control for not adopting PMV preferential treatment is performed at step S14, and the control for adopting PMV preferential treatment is performed at step S15.

Here, even when PMV preferential treatment is not adopted, there is a possibility that a PMV is selected accordingly. This is because it is judged that the PMV is more suitable than other motion vectors, and therefore there is no possibility that any problems arise. In addition, even when PMV preferential treatment is adopted, there is a possibility that a PMV is not selected accordingly. This is because it is judged that another motion vector is more suitable than the PMV vector, and therefore there is no possibility that any problems arise.

In addition, in this embodiment, when a predetermined situation is satisfied, only the control that makes a PMV advantageously selected is executed, and the control that makes a PMV forcibly selected is not executed. Therefore, even when the predetermined situation is satisfied, the control that makes a PMV not selected can be executed if the PMV is not an optimal motion vector. Because above described controls can be executed, it becomes possible that a suitable motion vector is selected and the number of erroneous detections is reduced.

As described above, when PMV preferential treatment is adopted, a PMV preferential treatment cost function value is calculated using Equation (4). By properly setting PMVoffset (a predetermined value) that is subtracted from a normal cost function value in Equation (4), a PMV can be made to be more advantageously selected than other motion vectors. In other words, by properly setting the value of PMVoffset, the accuracy of detected motion vectors can be improved. The value of PMVoffset can be a fixed value or a variable value. If the value of PMVoffset is set to be a variable value, the value can be changed depending on various predetermined situations.

The description that PMV preferential treatment is adopted when the predetermined situation is satisfied has been made above, the predetermined situation in the above-described embodiment is a situation where an edge is detected. As described above, a picture (an image) in which a PMV is recommendable to be preferentially selected is, for example, an image shown in FIG. 1. Referring FIG. 1 again, it can be found that spots where erroneous detection of motion vectors are apt to occur are spots where there are straight lines. There is a possibility that motion vectors are erroneously detected owing to lines regardless of vertical lines and horizontal lines. In addition, the same can be said for lattices. One of the reasons for the above-described things has been explained before with reference to FIG. 5 and FIG. 6.

To put it concretely, spots where motion vectors are apt to occur are spots where there are geometric edges. In such spots, vectors are apt to run wild. For example, if there is a diagonal line with a larger vertical component created while panning a camera, a motion vector is apt to vertically run wild. In addition, if there is a diagonal line with a larger horizontal component created while tilting a camera, a motion vector is apt to horizontally run wild. A situation where a motion vector is apt to run wild means a situation where the motion vector is apt to be erroneously detected, with the result that the detected motion vector has a direction and a magnitude different from those of an accurately detected motion vector.

Therefore, it is necessary that PMV preferential treatment is applied to an image (a picture) that has a geometric edge (or geographic edges). A geometric edge is, for example, a line. Around a line is there an edge between a part of a line and a part that is not a part of the line. Therefore, it can be said that a line provides a continuous edge. When such a continuous edge is detected, it is judged that a motion vector runs wild, and it is necessary to control the operation of the motion prediction unit so that PMV preferential treatment is adopted as described above with reference to the flowchart in FIG. 8.

To put it concretely, in the flowchart in FIG. 8, it is judged whether a edge is detected or not (more preferably, whether a continuous edge is detected or not) at step S13. If it is judged that an edge is detected, PMV preferential treatment is adopted at step S15. As above, this embodiment has been described by citing an example in which whether a motion vector runs wild or not is judged by judging whether an edge is detected or not. However, the judgment whether a motion vector runs wild or not (whether there is a possibility that an erroneous detection is executed or not) can be not only made by judging whether an edge is detected or not, but also can be made by other judgments.

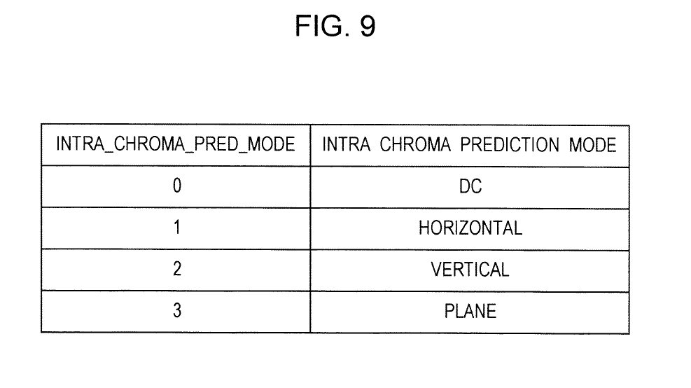

Description about the judgment whether a edge is detected or not will be made in detail below. When it is judged whether a edge is detected or not, information about Chroma Intra mode, which is one of AVC tools, is used. AVC Chroma Intra mode has four modes shown in FIG. 9. FIG. 9 is a table showing a color-difference signal intra prediction mode (Intra_chroma_pred_modes). Intra_chroma_pred_mode has four modes, that is, Mode 0, Mode 1, Mode 2, and Mode 3 as shown in FIG. 9.

An intra prediction of color-difference signals is performed in units of macroblocks. The prediction direction of the color-difference signal intra prediction is performed with reference to pixel values of adjacent already-encoded blocks that are situated to the left side, to the upper side, and to the upper left side of the current macroblock, and the four prediction modes shown in FIG. 9 are defined. Mode 0 is DC Prediction (an average value prediction mode), Mode 1 is Horizontal prediction (a horizontal prediction mode), Mode 2 is Vertical prediction (a vertical prediction mode), and Mode 3 is Plane Prediction (a plane prediction mode).

These modes are modes used for predicting a macroblock (referred to as macroblock prediction modes hereinafter), and not defined as modes for detecting an edge. However, in this embodiment, when detecting an edge at step S13 (in FIG. 8), the judgment whether there is an edge or not is made by judging which mode of these four modes the current macroblock prediction mode is. To put it concretely, when the current macroblock prediction mode is Mode 1 (a horizontal prediction mode) or Mode 2 (a vertical prediction mode), it is judged that an edge is detected, and PMV preferential treatment is adopted.

In this case, the process at step S13 is replaced with the process of judgment whether the current macroblock prediction mode is Mode 1 or Mode 2. If it is judged that the current macroblock prediction mode is Mode 1 or Mode 2, the flow proceeds to step S14 to perform PMV preferential treatment.

As described above, whether there is an edge or not can be judged using the current macroblock prediction mode. In other words, whether a vector is in the state of running wild or not can be judged using the current macroblock prediction mode. This enables the performance for detecting motion vectors to be improved without adding new hardware or software for detecting an edge. In other words, the performance for detecting motion vectors can be improved with the circuit size and processes kept as they are.

By adding a GlobalMV that indicates a motion vector regarding the movement of the entirety of a screen and an average InterSAD value calculated so far to the above-described embodiment, our choices can be narrowed down to more particular spots of the screen. In addition, the performance for detecting motion vectors can be more improved by lowering a Q value regarding a detected block.

When motion vectors largely deviates from their accurate figures, deterioration in image quality becomes conspicuous even though an image is encoded with a high bit rate. This embodiment can prevent the motion vectors from largely deviating from their accurate figures, with the result that the characteristics of the motion vectors can be improved and the improvement of image quality can be achieved.

[Storage Media]

The above-described series of processes can be performed by either hardware or software. If the series of processes are performed by software, a program including the software is installed on a computer. As a computer on which the program is installed, a computer equipped with dedicated hardware in which the program is embedded, and a general-purpose computer that is capable of performing a variety of functions using various programs installed on it, and the like are conceivable.

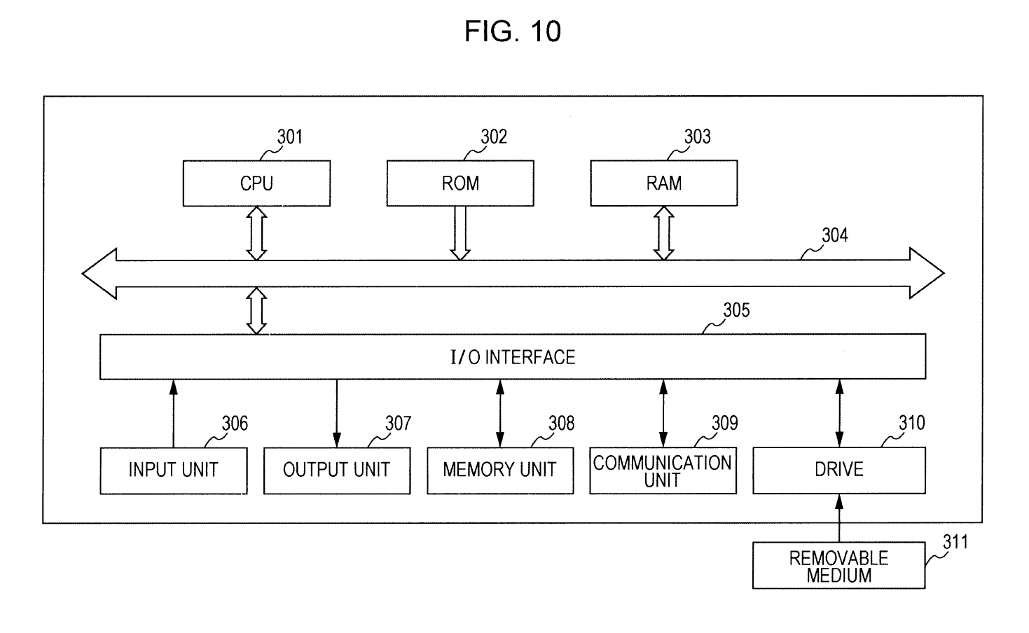

FIG. 10 is a block diagram showing a hardware configuration example of a computer that performs the series of processes using a program. In the computer, a CPU (central processing unit) 301, a ROM (read only memory) 302 and a RAM (random access memory) 303 are connected to each other through a bus 304. In addition, connected to the bus 304 is an I/O interface 305. Connected to the I/O interface 305 are an input unit 306, an output unit 307, a memory unit 308, a communication unit 309 and a drive 310.

The input unit 306 includes a keyboard, a mouse, a microphone and the like. The output unit 307 includes a display, a speaker and the like. The memory unit 308 includes a hard disk, a nonvolatile memory and the like. The communication unit 309 includes a network interface and the like. The drive 310 drives a removable medium 311 such as a magnetic disk, an optical disk, a magnet-optical disk, a semiconductor memory or the like.

In the computer configured as described above, the CPU 301 loads a program stored, for example, on the memory unit 308 onto the RAM 303 through the I/O interface 305 and the bus 304, and executes the program, with the result that the above-described processes are performed.

The program executed by the computer (the CPU 301) can be also presented, for example, in the form of being recorded on the removable recording medium 311 that is a kind of packaged medium. As an alternative, the program can also be presented through a wired or wireless transmission medium such as a local area network, the Internet, or digital satellite broadcasting.

After the removable medium 311 including the program is mounted on the drive 310, the computer can install the program on the memory unit 308 through the I/O interface 305. As an alternative, after receiving the program through a wired or wireless transmission medium, the communication unit 309 can install the program on the memory unit 308. As another alternative, the program can also be presented by installing the program on the ROM 302 or the memory unit 308 in advance.

The program executed by the computer can be a program that is executed in the time sequence described in this specification, can be a program some parts of which are executed in parallel, or can be a program that is executed in appropriate timing, for example, at the time when the program is called.

In this specification, the system refers to the entirety of an apparatus composed of plural devices.

An embodiment of the present disclosure is not limited to the above-described embodiment, but various modifications may be made without departing from the spirit and scope of the present disclosure.

The present disclosure contains subject matter related to that disclosed in Japanese Priority Patent Application JP 2010-292619 filed in the Japan Patent Office on Dec. 28, 2010, the entire contents of which are hereby incorporated by reference.

What is claimed is:

1. An image processing apparatus comprising:
a judgment unit that judges whether a continuous edge is detected or not in an image; and
a preferential treatment unit that treats a predictive motion vector more preferentially than other motion vectors when the judgment unit judges that a continuous edge is detected.

2. The image processing apparatus according to claim 1, wherein the judgment unit uses mode information in a chroma intra mode.

3. The image processing apparatus according to claim 1, wherein
the judgment unit judges that a continuous edge is detected when the chroma intra mode is a horizontal prediction mode or a vertical prediction mode.

4. The image processing apparatus according to claim 1, wherein
the preferential treatment unit subtracts a predetermined value from a cost function value of the predictive motion vector.

5. An image processing method that is performed by an image processing apparatus equipped with a judgment unit and a preferential treatment unit, comprising:
causing the judgment unit to judge whether a continuous edge is detected or not in an image; and
causing the preferential treatment unit to treat a predictive motion vector more preferentially than other motion vectors when the judgment unit judges that a continuous edge is detected.

6. A program that causes a computer for controlling an image processing apparatus equipped with a judgment unit and a preferential treatment unit to perform processing, comprising:
making the judgment unit judge whether a continuous edge is detected or not in an image; and
making the preferential treatment unit treat a predictive motion vector more preferentially than other motion vectors when the judgment unit judges that a continuous edge is detected.
